(19) United States
(12) Patent Application Publication
(10) Pub. No.: US 2026/0307621 A1
(43) Pub. Date: Oct. 8, 2026

(54) METHOD FOR ACTIVATING A VEHICLE FUNCTION AND ASSOCIATED ACTIVATION DEVICE

(71) Applicant: Continental Automotive Technologies GmbH, Hannover (DE)

(72) Inventors: Stéphane BILLY, Grenade (FR); Sylvain GODET, Villeneuve-lès-Bouloc (FR); Jérôme LEE, Toulouse (FR)

(73) Assignee: Continental Automotive Technologies GmbH, Hannover (DE)

(21) Appl. No.: 19/474,796

(22) PCT Filed: May 14, 2024
(86) PCT No.: PCT/EP2024/063261

§ 371 Date: Oct. 13, 2025

(30) Foreign Application Priority Data
Jun. 13, 2023 (FR) FR2305947

(51) Int. Cl. B60R 25/31; B60R 25/01; B60R 25/24; H04B 1/7163; H04W 4/40; H04W 4/80

(52) U.S. Cl. CPC B60R 25/31; B60R 25/01; B60R 25/24; H04B 1/7163; H04W 4/40; H04W 4/80; B60R 2325/10

(57) ABSTRACT

A method for activating a vehicle function, by an activation device, from an item of “hands-free” access equipment equipped with an accelerometer. The activation of the function triggered by detection of the access equipment in a predetermined zone and authenticating the access equipment. The device includes at least one transceiver to communicate with the access equipment in the ultra-wideband and at ultra-high frequency. The method includes: detecting, via ultra-high frequency, presence of the access equipment in the predetermined zone; authenticating the access equipment via ultra-high frequency; measuring acceleration of the access equipment; and if the measurements are representative of movement of the access equipment above a threshold from a last fixed position, then stopping the ultra-high-frequency communication, triggering the ultra-wideband communication, and activating the vehicle function; otherwise, if the measurements are representative of a static state of the access equipment, from a last fixed position, maintaining the ultra-high-frequency communication.

### CROSS REFERENCE TO RELATED APPLICATIONS

This application is the U.S. National Phase Application of PCT International Application No. PCT/EP2024/063261, filed May 14, 2024, which claims priority to French Patent Application No. FR2305947, filed Jun. 13, 2023, the contents of such applications being incorporated by reference herein.

### DESCRIPTION

### Field of the Invention

The invention relates to a method for activating a function of a motor vehicle and an associated activation device. The invention particularly, but in no way limitingly, applies to the function of hands-free access to a motor vehicle using a smartphone, the function being, for example, the function of locking and unlocking the opening elements of a motor vehicle.

### Background of the Invention

In a motor vehicle, it is known practice to use devices for activating a vehicle function which can detect the presence of a hand or a foot of a user of the vehicle and thus make it possible to lock or unlock all or some of the opening elements of the vehicle, for example the doors or the trunk. By way of example, the detection of the presence of a hand of a user on or in front of a door handle coupled with the recognition of an identifier of an item of “hands-free” access equipment carried by this user makes it possible to lock and unlock these opening elements.

A system for “hands-free” access to a motor vehicle makes it possible for an authorized user to lock and/or unlock the opening elements of their vehicle without having to physically press buttons on a key. For this purpose, the vehicle identifies an item of portable equipment such as a fob or a remote control or even a key carried by the user and, if the fob or the remote control or indeed the key is located in a predetermined zone around the vehicle or in the vehicle and is identified as belonging to the vehicle, then the vehicle automatically locks/unlocks its opening elements according to the intention of the user, without the user having to physically manipulate a key.

To do this, when the user approaches the vehicle, communication is established over a wireless communication link between the item of “hands-free” access equipment, for example an electronic fob or a smartphone, and the device for activating a vehicle function in order to authenticate said item of access equipment by virtue of its identifier.

To this end, the activation device comprises at least one radiofrequency antenna which makes it possible to receive the identifier sent by the item of “hands-free” access equipment. The activation device is connected to an electronic control unit (ECU) of the vehicle to which it transmits the identifier.

According to the location of the item of portable equipment identified by the vehicle, in said location zones, certain actions which are specific to said location zones are automatically carried out, unlocking/locking or turning on welcome lighting in the passenger compartment in advance.

Nowadays, however, it is increasingly common to use a cell phone to carry out authentication functions, which makes it possible to avoid using a dedicated electronic fob and thus to limit the number of items of equipment. Most cell phones do not have RF or LF communication means. It therefore becomes necessary to adapt the “hands-free” access and/or start-up system for a vehicle in order for it to be able to also operate with a mobile telephone equipped with other communication standards, such as, for example, ultra-wideband, UWB, or Bluetooth Low Energy®, or Wi-Fi (Wireless Fidelity) communication and no longer only via radio and low-frequency (RF and LF) waves. Ultra-wide band (UWB) in particular is a radio modulation technique which is based on transmitting pulses of very short duration, often of less than a nanosecond. Thus, the bandwidth can reach very large values.

Bluetooth communication is, for its part, communication at a frequency in the region of 2.4 GHz.

The method for activating a vehicle function using a mobile telephone, then, consists in:
a. detecting, by Bluetooth communication, the distant presence of the item of access equipment, that is to say in the region of 100 m around the vehicle, and establishing a first Bluetooth communication link between the item of access equipment and the activation device,
b. recognizing the identifier received via Bluetooth by the vehicle,
c. then detecting, by UWB, the close presence of the item of access equipment, that is to say within a radius of a few meters, for example about 10 m to 15 m around the vehicle, and precisely locating, in UWB, the position of said item of equipment in order to activate vehicle security functions such as unlocking, locking etc.

However, this method has a major drawback when the vehicle is parked within a radius of 10 m to 15 m around the item of access equipment and the user does not wish to activate a vehicle function. For example, when the vehicle is parked in a garage and the item of access equipment is placed in a receptacle located in the house adjoining the garage. In this case, all the steps of the above method will be carried out, and the vehicle will be unlocked, then locked, then unlocked and so on cyclically without the user wishing to activate these functions.

The scenario is even more critical when the vehicle is parked in front of the house where the item of portable equipment is permanently located within the UWB communication radius. The vehicle is then unlocked at a recurring frequency and can therefore be easily stolen.

Another non-negligible drawback of this prior art method lies in the fact that the battery of the vehicle and the battery of the item of access equipment will drain very quickly, since they are overloaded by these recurring requests and these cyclical locking and unlocking actions. This reduces their service life.

An aspect of the invention therefore proposes a method for activating a vehicle function and an associated activation device which mitigate the drawbacks of the prior Substitute Specification art and thus eliminate the risk of the vehicle being stolen and prolong the service life of the batteries of the vehicle and of the item of portable equipment.

### SUMMARY OF THE INVENTION

An aspect of the invention relates to a method for activating a vehicle function, by means of an activation device, from an item of “hands-free” access equipment which is able to be carried by a user, the item of access equipment being equipped with an accelerometer, the activation of the function being triggered by a detection of the presence of the item of equipment in a predetermined zone around the vehicle, and depending on a result of authenticating the item of equipment, the activation device comprising at least one transceiver which is able to communicate with said item of equipment in the ultra-wideband and at ultra-high frequency, the method being remarkable in that it comprises the following steps:
a. detecting, via ultra-high-frequency communication, a presence of the item of access equipment in a predetermined zone around the vehicle,
b. authenticating said item of equipment via ultra-high-frequency communication,
c. measuring the acceleration of the item of access equipment, and
d. if said measurements are representative of a movement of the item of access equipment which is above a threshold from a last fixed position, then stopping the ultra-high-frequency communication and triggering the ultra-wideband communication, and activating the vehicle function,
e. otherwise, if said measurements are representative of a static state of the item of access equipment, from a last fixed position, then maintaining the ultra-high-frequency communication.

In an improvement to the activation method according to an aspect of the invention, if said measurements are representative of a movement of the item of access equipment between a minimum movement and the threshold, then the ultra-high-frequency communication is stopped and the ultra-wideband communication is triggered at a reduced transmission frequency and the vehicle function is activated.

Preferably, said acceleration measurements are transmitted by the item of access equipment to the activation device.

An aspect of the invention also relates to a device for activating a function of a motor vehicle intended to be installed in the vehicle, the activation of the function being triggered by a detection of the presence of an item of portable “hands-free” access equipment, which is able to be carried by a user, in a predetermined zone around the vehicle and depending on a result of the vehicle authenticating said item of equipment, the activation device comprising at least one transceiver for transceiving in the ultra-wideband and at ultra-high frequency which is able to communicate with said item of equipment in the ultra-wideband and at ultra-high frequency, the device being remarkable in that it further comprises:
a. means for detecting, via ultra-high frequency, a presence of the item of access equipment in a predetermined zone,
b. means for authenticating, in ultra-high frequency, said item of equipment,
c. means for receiving, in ultra-high frequency, acceleration values originating from said item of equipment,
d. means for stopping or maintaining the ultra-high-frequency communication and means for triggering the ultra-wideband communication depending on said acceleration values from a last fixed position.

In the improvement mode, the device further comprises means for triggering the ultra-wideband communication with a reduced frequency depending on said acceleration values from a last fixed position.

An aspect of the invention also applies to any computer program product comprising program code instructions for executing the steps of the method according to any one of the features listed above when said program is executed on a computer.

An aspect of the invention also relates to any item of equipment for “hands-free” access to a motor vehicle, which is able to be carried by a user, characterized in that it comprises an accelerometer, means for measuring acceleration values and means for transmitting acceleration values in ultra-high frequency.

Finally, an aspect of the invention applies to any motor vehicle comprising an activation device according to any one of the features listed above.

### BRIEF DESCRIPTION OF THE DRAWINGS

Other features and advantages of aspects of the invention will become more clearly apparent upon reading the following description. It is purely illustrative and should be read with reference to the attached drawings, in which:

FIG. 1 schematically depicts the vehicle equipped with the activation device according to an aspect of the invention, with an item of portable equipment in static position, located in a predetermined vicinity around the vehicle,
FIG. 2 schematically depicts the vehicle equipped with the activation device according to an aspect of the invention, with an item of portable equipment in movement, the movement being above a threshold, located in a predetermined vicinity around the vehicle,
FIG. 3 schematically depicts the vehicle equipped with the activation device according to an aspect of the invention, with an item of portable equipment in movement, the movement being between a minimum movement and a threshold, located in a predetermined vicinity around the vehicle,
FIG. 4 schematically depicts the activation device according to an aspect of the invention,
FIG. 5 is a flow diagram depicting the various steps of the activation method according to an aspect of the invention.

### DETAILED DESCRIPTION OF EXEMPLARY EMBODIMENTS

FIG. 1 depicts a motor vehicle V equipped with the activation device D according to an aspect of the invention. The activation device D comprises at least two ultra-wideband, UWB, and Bluetooth, BLE, ultra-high-frequency transceivers EM1, EM2, EM3, EM4 which are able to communicate in the ultra-wideband and BLE with an item of portable access equipment SD carried by a user U.

The activation device D further comprises a central control unit 10 electronically connected to all the Bluetooth LE and UWB transceivers EM1, EM2, EM3, EM4.

This central control unit 10 makes it possible to manage the transmission and the reception of the UWB and Bluetooth LE data via the transceivers. This is known from the prior art and will not be described in further detail here.

Ultra-wideband (UWB) communication is understood to mean radio-frequency communication which is based on the transmission of pulses of very short duration, often of less than a nanosecond. Thus, the bandwidth can reach very large values between 250 and 500 MHz.

Bluetooth LE (Bluetooth Low Energy) communication is understood to mean ultra-high-frequency communication in the region of 2.4 GHz.

As already explained, the activation method of the prior art consists in:
a. detecting, by Bluetooth LE communication, the distant presence of the item of access equipment SD, that is to say in the region of 100 m around the vehicle V, and establishing a first Bluetooth Low Energy communication link between the item of access equipment SD and the activation device D, by virtue of at least one transceiver,
b. receiving, in BLE, an identifier of said item of equipment SD via the vehicle, and recognizing it as being an identifier of an item of portable equipment associated with the vehicle V in advance,
c. then detecting, by UWB communication, by virtue of at least one transceiver of the activation device D, the close presence of the item of access equipment, that is to say in a zone Z1 which is close to the vehicle, for example between 0 and 15 m around the vehicle, and locating the position of said item of equipment SD precisely,
d. activating a vehicle function F1 depending on the distance separating said item of equipment SD from the vehicle V, for example automatically unlocking the door when the user is close to the door, or turning on the air conditioning, the heating or the radio or controlling the vehicle V remotely for the automatic parking mode, when the user U is a few meters from their vehicle.

As explained above, if the item of access equipment SD is within the ultra-wideband communication UWB radius, the vehicle function is activated even if the user did not want it, which poses a real security and battery life problem.

An aspect of the invention proposes an activation device D which mitigates the drawbacks of the prior art.

According to an aspect of the invention, the item of “hands-free” access equipment SD comprises an integrated accelerometer ACC and is able to measure acceleration values according to time t and to transmit these said values to the activation device D.

The item of access equipment SD also comprises a processor 200 and a memory 201 (cf. FIG. 4) which stores instructions making it possible to configure the processor to execute certain particular processing operations, notably to implement the steps of the activation method, according to the embodiment described below.

Still according to an aspect of the invention, the activation device D, for its part, further comprises (cf. FIG. 4):
a. means M1 for detecting, via ultra-high frequency, a presence of the item of access equipment SD in a predetermined zone Z1,
b. means M2 for authenticating, in ultra-high frequency, said item of equipment SD,
c. means M3 for receiving, in ultra-high frequency, the acceleration values originating from said item of equipment SD,
d. means M4 for stopping or maintaining the ultra-high-frequency communication and means M5 for triggering the ultra-wideband communication depending on said acceleration values.

In an improvement to an aspect of the invention, the activation device further comprises means M6 for reducing an ultra-wideband communication UWB frequency depending on said acceleration values.

Preferably, but in no way limitingly, the detection means M1, the authentication means M2, the reception means M3 and the means M4 for stopping or maintaining the ultra-high-frequency communication and the means M5 for triggering the ultra-wideband communication are contained in the central control unit 10 (cf. FIG. 4) and are partially or entirely in the form of software.

The central control unit 10 also comprises a processor 100 and a memory 101 (cf. FIG. 4) which stores instructions making it possible to configure the processor to execute certain particular processing operations, and notably to implement the steps of the activation method, according to the embodiment described below.

The detection means M1 consist of means for transceiving and processing the data received from the item of access equipment SD via ultra-high frequency, contained in the transceivers EM1, EM2, EM3, EM4 and in the central control unit 10. Said means make it possible to detect the presence of said item of equipment in a predetermined zone Z1 around the vehicle with a radius of 10 m to 15 m. This is known from the prior art.

The authentication means are in the form of software which makes it possible to recognize the identifier ID of the item of access equipment SD, and to authenticate it in order to detect whether said item of equipment is indeed authorized to activate the functions of the vehicle V. This is known from the prior art.

The means M3 for receiving the acceleration values ACC(t) from the item of access equipment consist of the transceivers EM1, EM2, EM3, EM4 and the central control unit 10.

The means M4 for stopping or maintaining the ultra-high-frequency communication BLE and the means M5 for triggering the ultra-wideband communication UWB depending on said acceleration values are in the form of software.

More particularly, upon receiving the acceleration values ACC(t) according to time, the activation device D determines a movement d1, d2 (cf. FIGS. 2 and 3) or a distance d travelled by the activation device D according to time, more particularly from the last static position of said item of equipment which was stored.

The determination of a movement d1, d2 from a prior position P1 of the item of access equipment SD by virtue of the acceleration values ACC(t) is known to a person skilled in the art. A person skilled in the art knows, indeed, how to calculate a distance d1, d2 on the basis of acceleration values ACC(t) according to time and a starting position; this will therefore not be described in detail here.

The means M4 for stopping or maintaining the ultra-high-frequency communication and the means M5 for triggering the ultra-wideband communication UWB depending on said acceleration values ACC(t) therefore comprise:
a. means for calculating a distance d1, d2 travelled by the item of access equipment SD depending on said acceleration data,
b. means for comparing said distance d1, d2 with a threshold value ds; for example, ds is equal to 50 cm,
c. means for stopping the ultra-high-frequency communication BLE and triggering the ultra-wideband communication UWB if the distance d1, d2 is greater than the threshold value ds,
d. means for maintaining the ultra-high-frequency communication BLE, if the distance d1, d2 is less than the threshold value ds.

In an improvement to an aspect of the invention, the activation device D further comprises:
a. means M7 for comparing said distance d1, d2 with a minimum movement value dmin,
b. means M8 for stopping the ultra-high-frequency communication BLE and initiating the ultra-wideband communication BLE with a reduced transmission frequency F, if the distance d1, d2 is greater than the minimum movement dmin but less than the threshold value ds.

This will be explained below.

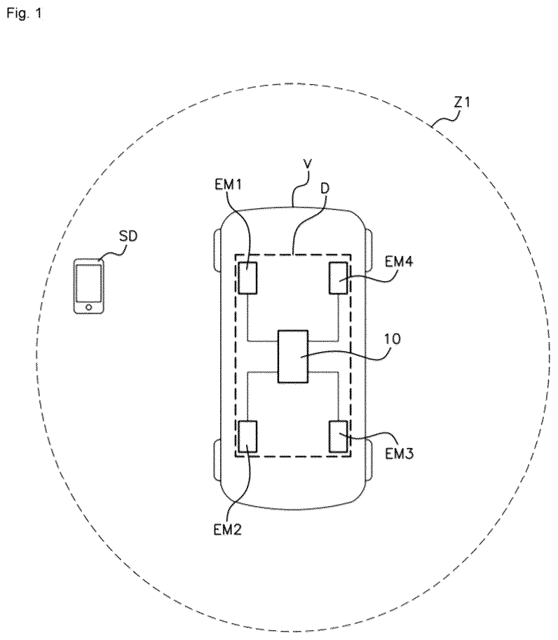

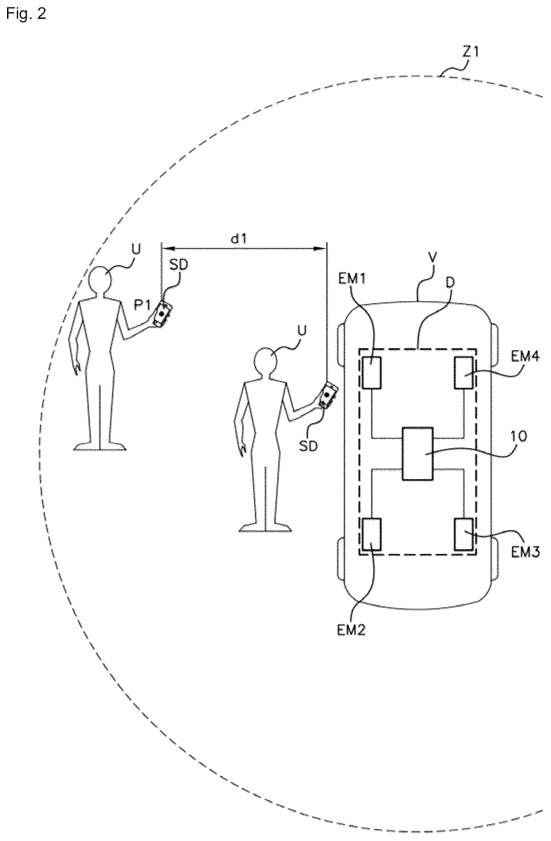

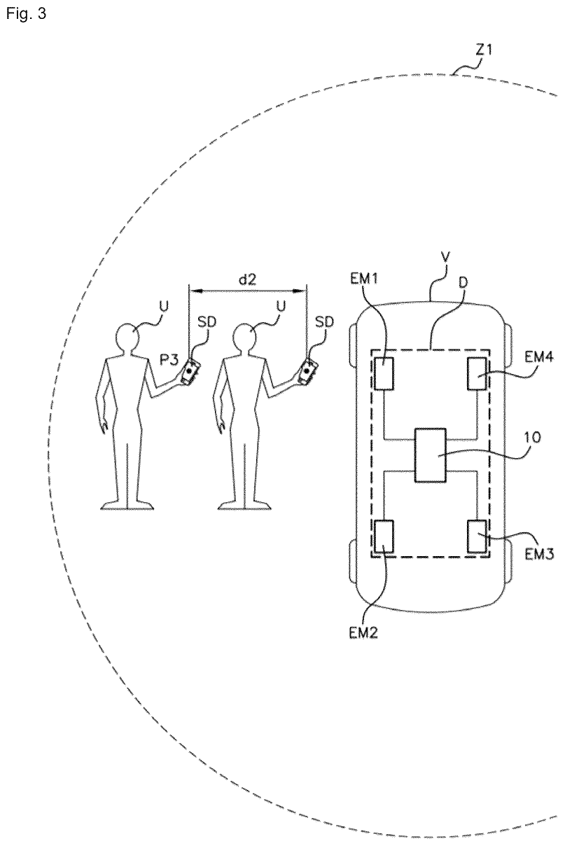

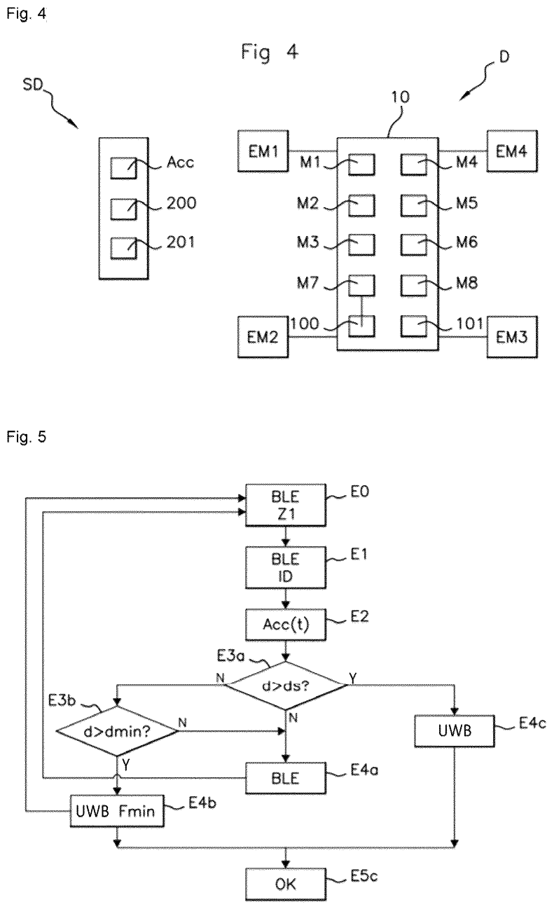

The activation method according to an aspect of the invention, which is illustrated in FIG. 5, will now be described.

In a preliminary step E0, ultra-high-frequency communication BLE is established between the activation device D and the item of access equipment SD. This communication is made possible since the item of access equipment SD is located in a predetermined zone Z1 around the vehicle which is contained in the BLE communication range of the vehicle V.

In a first step E1, the item of access equipment SD is authenticated; for this purpose, it exchanges its own identifier ID via ultra-high-frequency communication with the activation device D, which verifies that said item of equipment was indeed paired with the vehicle in advance and is authorized to activate vehicle functions.

In a second step E2, the item of access equipment measures according to time t and stores acceleration values ACC(t) by virtue of its integrated accelerometer ACC.

Preferably, the acceleration measurements ACC(t) are carried out continuously, stored and transmitted to the activation device D.

The distance d1, d2 travelled is determined by the activation device D from a prior static position of the item of equipment SD which was stored for a predetermined time At in advance. For example, the item of access equipment SD remained in static position for Δt=5 s, and therefore its acceleration values did not change during this predetermined time; the next estimate of distance d travelled will be carried out from this static position, and from the measurements of the acceleration of the item of access equipment SD which were received by the activation device D from said static position.

The distance d1, d2 travelled is calculated continuously or at a fixed frequency.

During a third step E3a, the distance d1, d2 travelled thus estimated by virtue of the acceleration values received from the last stored static position is compared with a threshold value ds. For example, ds=50 cm.

If the distance d1, d2 travelled from the last static position is greater than the threshold value of 50 cm, then the ultra-high-frequency communication BLE is stopped and the ultra-wideband communication UWB is initiated (step E4c). This is illustrated in FIG. 2; the distance d1 travelled from the static position P1 is greater than ds=50 cm.

Indeed, it is then considered that the user has moved notably with respect to their vehicle and consequently that they wish to activate a vehicle function.

The UWB communication then makes it possible to locate the item of access equipment SD more precisely around the vehicle V in the predetermined zone Z1, and to activate a vehicle function depending on its position (step E5c).

If the distance d1, d2 travelled from the last static position is less than the threshold value ds of 50 cm, then the ultra-high-frequency communication BLE is maintained (step E4a). Indeed, in this case, the movement of the user is not considered to be significant and sufficient to detect an intention to activate a vehicle function. The BLE communication is therefore maintained and the method returns to the ultra-high-frequency communication step E0.

In an improvement to an aspect of the invention, if the distance d1, d2 travelled from the last static position is less than the threshold value ds of 50 cm, but greater than a minimum movement, for example dmin of 10 cm (step E3b), then the ultra-high-frequency communication BLE is stopped and the ultra-wideband communication UWB is initiated but with a reduced transmission frequency Fmin (step E4b). Otherwise, the ultra-high-frequency communication BLE is maintained.

For example, the ultra-wideband UWB transmission frequency is located around 10 Hz and the reduced UWB transmission frequency Fmin can be located in the region of 2 Hz.

It is considered, in this case, that the user has moved or started to move; it is therefore wise to initiate the ultra-wideband communication UWB. However, as the movement is of low amplitude, it is preferable to reduce the transmission frequency in order to reduce the energy consumption of the batteries. This is illustrated in FIG. 3; the distance d2 travelled from the static position P3 is between 20 cm and 50 cm.

An aspect of the invention is particularly ingenious because it makes it possible to notably reduce the risk of vehicle theft as well as increase the service life of the battery of the item of access equipment and to a lesser extent that of the vehicle.

The UWB communication is, indeed, activated only when a notable movement of the user is detected.

The invention is particularly easy to implement and inexpensive, because the device comprises above all software means. The following listing of claims will replace all prior versions and listings of claims in this

1. A method for activating a vehicle function, by an activation device, from an item of “hands-free” access equipment which is able to be carried by a user, the item of access equipment being equipped with an accelerometer (ACC), the activation of the function being triggered by a detection of the presence of the item of equipment in a predetermined zone around the vehicle, and depending on a result of authenticating the item of equipment, the activation device comprising at least one transceiver which is able to communicate with said item of equipment in the ultra-wideband (UWB) and at ultra-high frequency, the method comprising:
a) detecting, via ultra-high-frequency communication, a presence of the item of access equipment in a predetermined zone around the vehicle,
b) authenticating said item of equipment via ultra-high-frequency communication,
c) measuring the acceleration of the item of access equipment, and
i) upon receiving the acceleration values according to time, the activation device determines a movement or a distance travelled according to time, from a last fixed position of said item of equipment which was stored,
ii) if said measurements are representative of a movement of the item of access equipment between a minimum movement and the threshold, then stopping the ultra-high-frequency communication and triggering the ultra-wideband communication at a reduced transmission frequency and activating the vehicle function depending on the position of the item of access equipment,
iii) otherwise, if said measurements are representative of a static state of the item of access equipment from a last fixed position, then maintaining the ultra-high-frequency communication.

2. The activation method as claimed in claim 1, wherein said acceleration measurements are transmitted by the item of access equipment to the activation device.

3. A device for activating a function of a motor vehicle intended to be installed in the vehicle, the activation of the function being triggered by a detection of the presence of an item of portable “hands-free” access equipment, which is able to be carried by a user, in a predetermined zone around the vehicle, and depending on a result of the vehicle authenticating said item of equipment, the activation device comprising at least one transceiver for transceiving in the ultra-wideband and at ultra-high frequency which is able to communicate with said item of equipment in the ultra-wideband and at ultra-high frequency, the device further comprising:
a) means for detecting, via ultra-high frequency, a presence of the item of access equipment in a predetermined zone,
b) means for authenticating, in ultra-high frequency, said item of equipment,
c) means for receiving, in ultra-high frequency, acceleration values originating from said item of equipment,
d) means for stopping or maintaining the ultra-high-frequency communication and means for triggering the ultra-wideband communication depending on said acceleration values from a last fixed position,
e) means for triggering the ultra-wideband communication with a reduced frequency depending on said acceleration values from a last fixed position if said measurements are representative of a movement of the item of access equipment between a minimum movement and the threshold.

4. A motor vehicle, comprising an activation device as claimed in claim 3.
